(19) United States
(12) Patent Application Publication
(10) Pub. No.: US 2009/0212458 A1
(43) Pub. Date: Aug. 27, 2009

(54) METHOD AND APPARATUS FOR FORMING ARTICLES FROM MOULDABLE MATERIALS

(76) Inventor: Peter Michael Woodworth, Wepre (GB)

Correspondence Address: Zilka-Kotab, PC, P.O. BOX 721120, SAN JOSE, CA, 95172-1120, US

(21) Appl. No.: 12/298,763

(22) PCT Filed: Apr. 20, 2007
(86) PCT No.: PCT/GB2007/001433

§ 371 Date: Feb. 2, 2009

(30) Foreign Application Priority Data
Apr. 26, 2006 (GB) 0608216.8

(51) Int. Cl. B29C 47/00; B29C 45/00

(52) U.S. Cl. 264/176.1; 264/328.1; 425/130; 425/131.1

(57) ABSTRACT

A method and apparatus for forming an article from mouldable material is disclosed. A mouldable material, such as a thermoplastic is heated until it is molten and is fed into an injector (900) of an injection moulding apparatus. A liquid, such as water, is introduced (930) into the stream of molten plastic. Because the molten plastic is at a temperature above the boiling point of the water, the water will boil and will expand the plastic material forming a honeycomb structure of bubbles that remains once the material has cooled.

The present invention relates to a method and apparatus for forming articles from mouldable materials and relates particularly, but not exclusively, to a method and apparatus for injection moulding and extruding thermoplastic materials.

The use of blowing and foaming agents in moulding and extrusion processes of thermoplastic and metallic materials is well known. The use of physical and chemical agents in such moulding and extruding processes results in a so-called honeycomb structure of bubbles being formed within the thermoplastic or metal material. This reduces the weight of the article so formed and reduces the formation distortions including sink marks which result from an excessive thickness of plastic material being used in a mould.

Typical examples of methods of producing such articles include the addition of physical agents, such as gases, to produce the air pockets. Typically reasonably inert gases such as carbon dioxide or nitrogen are used to reduce the risk of oxidisation since the gases introduced to the material being moulded when it is at high temperatures, that is above its melting point. As a result, there are significant costs in producing or purchasing suitable gases.

Alternatively, chemical agents can be used which are mixed with the solid granulated polymer before it is heated. The cold polymer and chemical agent are heated and compressed during processing and a gas is produced by the chemical agent. This gas produces a foaming within the molten thermoplastic resulting within the honeycomb structure.

Preferred embodiments of the present invention seek to overcome disadvantages of the prior art, including, but not limited to, those set out above.

According to an aspect of the present invention, there is provided a method of forming an article from at least one mouldable material, comprising the steps of:—

heating at least one mouldable material to a first temperature at which said material becomes substantially molten;
feeding said molten material through an article forming apparatus; and
introducing at least one liquid into said molten material wherein at least one said liquid boils at a second temperature less than said first temperature.

By introducing a liquid into an article forming process, such as injection moulding or extrusion, where the liquid has a boiling point below the temperature of the molten material into which it is introduced, the advantage is provided that the liquid acts as a blowing agent by boiling thereby introducing bubbles of its vapour within the molten material. This bubble structure remains as the molten material solidifies producing the desired honeycomb structure. It has been found that in spite of thorough mixing of the liquid and the molten material that the external surface of the re-solidified material has a smoothed surface, or external skin, whilst the open structure of bubbles remains below the skin's surface. The expansion of the molten material produces an article that has the benefits of reduced weight without the disadvantages of an irregular and aesthetically unsatisfactory external surface. Furthermore, the introduction of water into the molten material reduces the viscosity in turn reducing the pressure needed to inject the mixture into the mould or extrusion process. The water also assists in the cooling of the article being formed. A further advantage is that when some normally pliable thermoplastics (for example HDPE) are heated to very high temperatures in the moulding process, the water can supersaturate the HDPE. Once the HDPE has expanded a brittle material is produced with properties similar to the harder crystalline polymers, which are generally more expensive than HDPE.

In a preferred embodiment at least one said liquid comprises water.

By using water as the liquid introduced into the molten material, the advantage is provided that a cheaply available and environmentally benign blow foaming agent can be used. As a result, not only are the blowing agent purchase costs reduced to virtually nil, the clean up costs are similarly significantly reduced.

In another preferred embodiment at least one said mouldable material comprises a thermoplastic.

The article may be formed by injection moulding or by extrusion.

According to another aspect of the present invention there is provided a liquid adding device for attaching to an apparatus for forming articles from at least one mouldable material, the device comprising:—

insertion means for introducing at least one liquid into an apparatus for forming articles from at least one mouldable material;
valve means for allowing the or each liquid to enter said apparatus and mix with at least one said mouldable material and to prevent mouldable material from passing through said valve.

The device described above can be added to a new and/or an existing injection moulding or extrusion apparatus and/or mould and provides all of the advantages set out above.

In a preferred embodiment said valve means comprises a viscosity valve.

In another preferred embodiment said viscosity valve comprises at least one sintered material which is porous with regard to the or each liquid and non-porous to said molten material.

The device may be adapted to be attached to a nozzle of an injection moulding or extrusion apparatus.

According to a further aspect of the present invention, there is provided an apparatus for forming articles from at least one mouldable material, the apparatus comprising:—

heating means for heating at least one mouldable material until it becomes substantially molten;
at least one liquid adding device as defined above for mixing at least one liquid into at least one molten mouldable material; and
shaping means for forming said molten material into at least one article.

The shaping means may comprise at least one mould or may comprise extruding means.

Preferred embodiments of the present invention will now be described by way of example only, and not in any limitative sense, with reference to the accompanying drawings in which:—

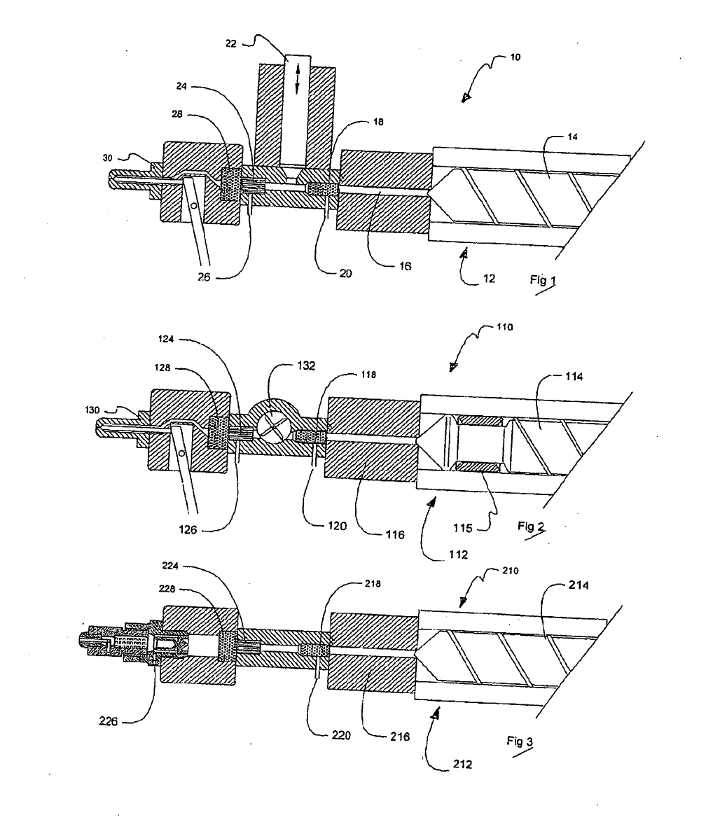

FIG. 1 is a sectional view of an injection moulding apparatus of an embodiment of the present invention;

FIG. 2 is a sectional view of an injection moulding apparatus of another embodiment of the present invention;

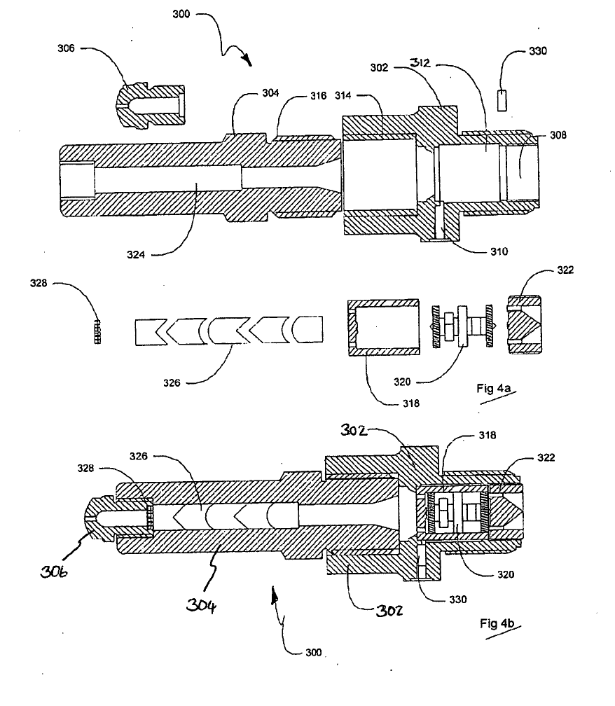

FIG. 3 is a sectional view of an extruding apparatus of a further embodiment of the present invention;

FIG. 4a is a sectional view showing components which combine to form a nozzle of an injection moulding device of an embodiment of the present invention;

FIG. 4b is a sectional view showing the components in FIG. 4a assembled;

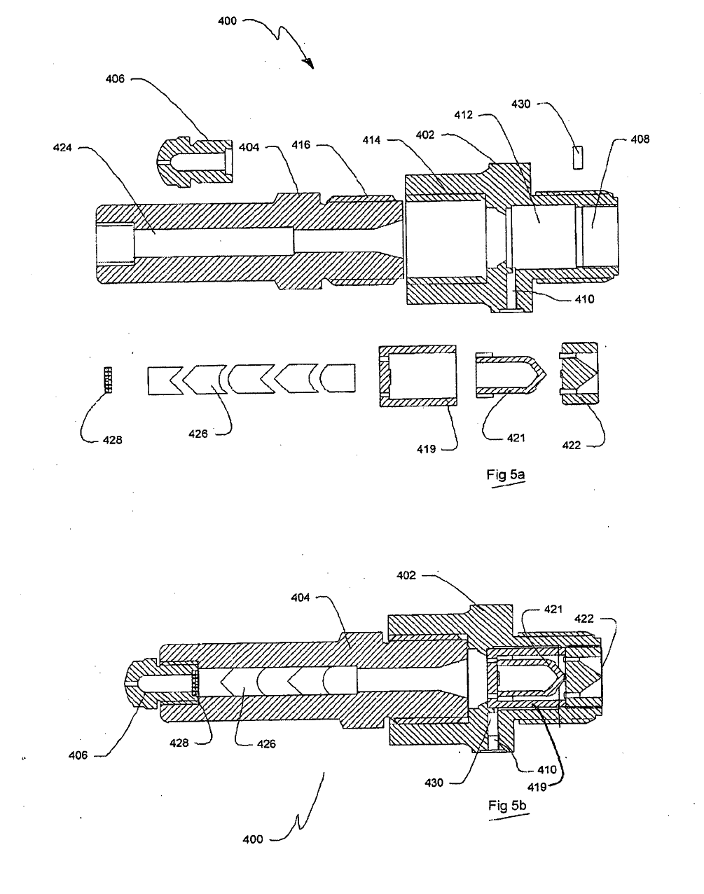

FIG. 5a is a sectional view showing components which combine to form a nozzle of an injection moulding device of another embodiment of the present invention;

FIG. 5b is a sectional view showing the components in FIG. 5a assembled;

FIG. 6 is a sectional view showing a nozzle of an extrusion device of a further embodiment of the present invention;

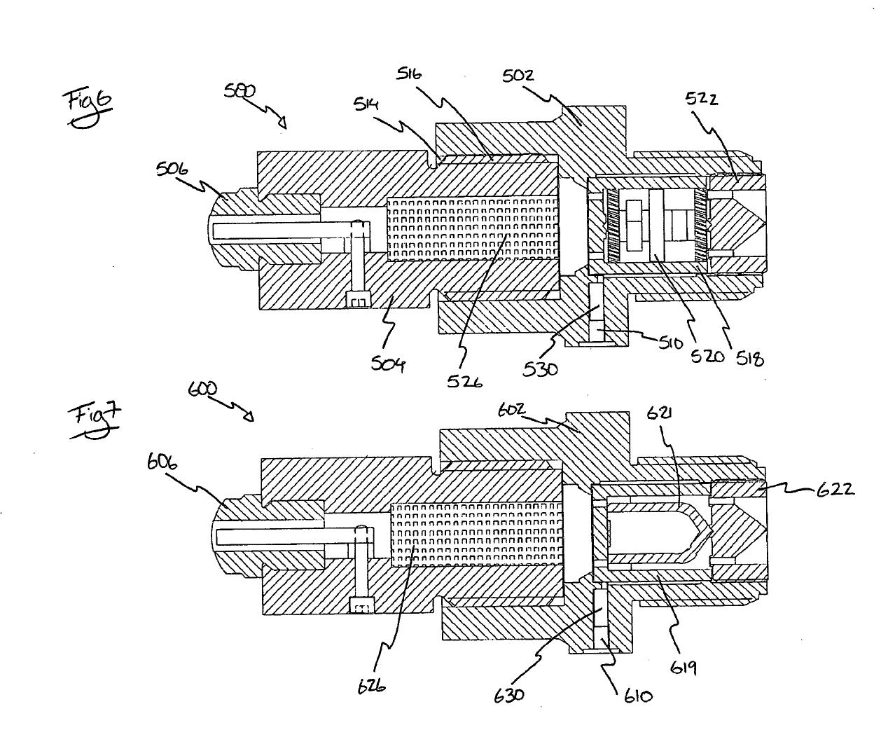

FIG. 7 is a sectional view showing a nozzle of an extrusion device of a further embodiment of the present invention;

FIG. 8a is an end view of part of a nozzle of the present invention;

FIG. 8b is a sectional view along the line A-A;

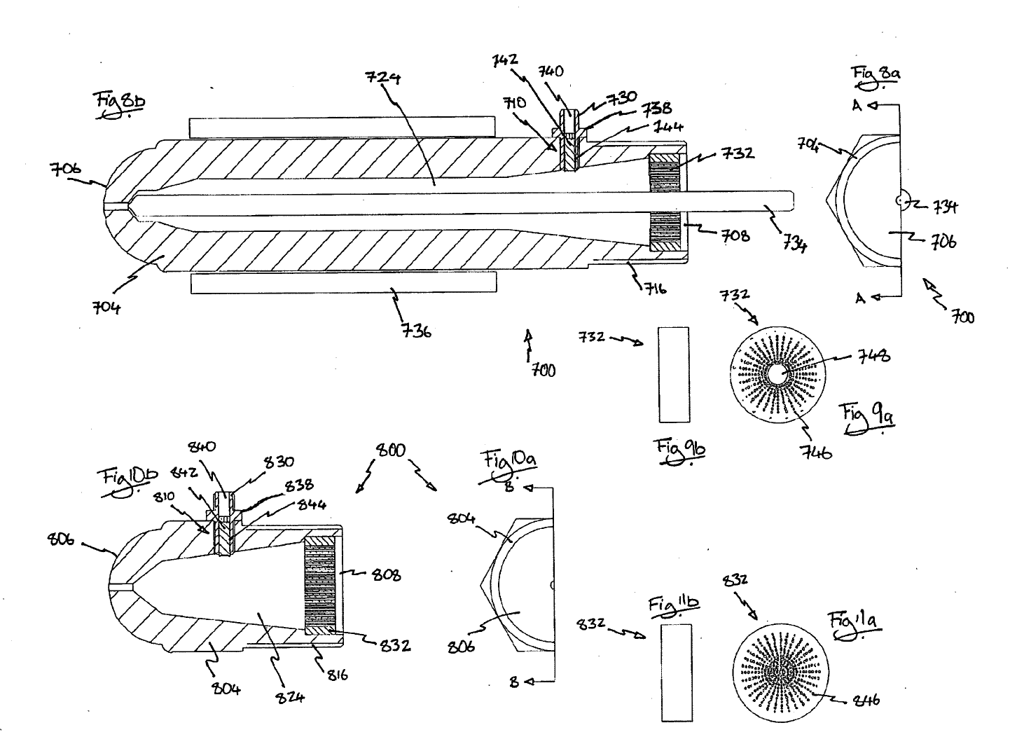

FIGS. 9a and 9b are front and side views of a diffuser used in the present invention;

FIG. 10a is an end view of part of another nozzle of the present invention;

FIG. 10b is a sectional view along the line B-B;

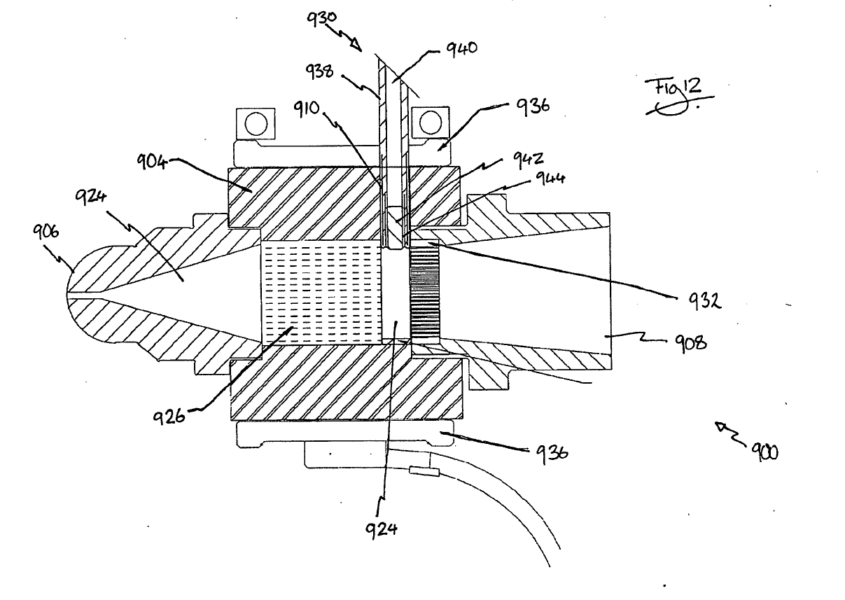

FIGS. 11a and 11b are front and side views of another diffuser used in the present invention; and

FIG. 12 is a sectional view of a further nozzle of the present invention.

Referring to FIG. 1, an apparatus 10 for injection moulding a thermoplastic material has a feeding device 12 for feeding molten thermoplastic material. The thermoplastic material is fed, under the force of threaded feed screw 14 along passage 16 to a static viscosity mixer valve 18 which also has a water inlet 20. A plunger 22 applies pressure to the molten thermoplastic causing it to pass through a second static viscosity mixer valve 24 which includes a further water inlet 26. The apparatus 10 also has a static mixer or diffuser 28 and an outlet nozzle 30.

In use, molten thermoplastic is forced through feed device 12 by feed screw 14 into passageway 16. From the passageway 16 the molten thermoplastic enters the static viscosity valve 18 where water is introduced through inlet 20 at a relatively low pressure. The saturated mixture passes through the static viscosity mixer 18 which includes a block of irregularly placed holes that allow the molten mixture to pass and deflect its direction of flow. By altering the direction of flow, the mixture is broken up and at some points its direction is momentarily reversed, thereby causing thorough mixing of the thermoplastic and water. The mixture can effectively become a melt colloid with tiny droplets of water suspended in the molten thermoplastic.

The pressure of the thermoplastic and water mixture is increased by plunger 22 which forces the mixture through a second static viscosity mixer valve 24 at relatively higher pressure and into diffuser 28. Insertion of water before or after plunger offers a choice of high or low pressure mixing, or both. Counter pressure may be added to the plunger to further compress and agitate the mixture. Because water has a significantly lower viscosity than the thermoplastic, the resulting mixture's viscosity is lower than the thermoplastic alone. As a result it is not always necessary to further heat the mixture to take account of the heat lost due to the addition of water. Furthermore, the mixture is less likely to pass back through higher viscosity thermoplastic. This also allows counter pressure to be applied to the mixture. The application of counter pressure can be achieved by the feed screw or by the plunger.

However, it should be noted that, for some polymers, it may be necessary to increase the temperature of the apparatus directly around the mixture to ensure that the added liquid does not cause the materials to solidify within the injection moulding apparatus.

The mixture passes through outlet nozzle 30 at which point the high pressure at which the thermoplastic and water mixture has been held is released and the water, which has been heated by the thermoplastic material, instantly boils and results in expansion of the thermoplastic material, forming bubbles of vapour within the mixture. On entering the mould, to which the apparatus 10 is attached to or pressed against, the thermoplastic material cools and solidifies, trapping the bubbles of water vapour therein to form a so-called honeycomb structure.

As an alternative, the water can be introduced through the inlet 26 when the thermoplastic material is at a higher pressure. The mixing then takes place in the static viscosity mixer 24 before passing through the diffuser 28 and to outlet nozzle 30 as previously described

Referring to FIG. 2, in which parts common to those of FIG. 1 are denoted with like referenced numerals increased by 100, the feed screw 114 is fitted with a check ring 115 which prevents thermoplastic material from passing along the feed device 112 in the wrong direction, away from outlet nozzle 130, and therefore allows the feed screw to create all of the pressure necessary to perform the injection moulding operation. As a result, the plunger 22, seen in FIG. 1, is not necessary in apparatus 110. A turbulent mixer 132 which may have a speed controller is included to ensure that the water and thermoplastic are thoroughly mixed.

In device 110, the difference between introducing water through inlet 120 as opposed to inlet 126 is that if water is introduced through inlet 120 it goes through the additional mixing stage of passing through turbulent mixer 132. Insertion of water before or after mixer 132 offers a choice of high or low pressure mixing, or of course both. Counter pressure may be added to the mixer 132 to further compress and agitate the mixture. The use of high or low pressure mixing is one of the factors used to determine the characteristics of the formed material. For example, high or low pressure mixing can determine whether the bubbles or voids in the material are open or closed. Open voids are connected bubbles which allow air to pass through them giving a spongy material and closed voids are separate giving a more rigid structure.

Referring to FIG. 3, in which parts in common with those of FIG. 2 are denoted with like referenced numerals increased by 100, the apparatus 210 is a simplified version of that shown in FIG. 2. The turbulent mixer 132 of FIG. 2 has been removed and a single water inlet 220 introduces water into a first static viscosity mixer/valve. The second water inlet and viscosity mixer/valve is contained within the extruder attachment and acts as a static mixing mechanism in the form of a die head.

Referring to FIGS. 4a and 4b, a nozzle 300 for an injection moulding apparatus has externally visible components of a mixer body 302, a nozzle body 304 and a nozzle tip 306. Mixing body 302 has a first inlet 308 which receives molten thermoplastic material and a second inlet 310 for receiving water. The inlets are both received in a mixing zone 312. The mixer body 302 has an internal thread 314 which engages an external thread 316 on nozzle body 304. Within the mixing zone 312 there is a porous turbine body 318 that further acts as a viscosity valve forming a barrier between the molten thermoplastic and the water/steam but permitting mixing and distributing of the water/steam into the molten thermoplastic with the water becoming sufficiently dispersed to form a suspension of water in the thermoplastic. The turbine body 318 contains a turbine mixer 320 for turning and agitating during water/thermoplastic mixing. An injector 322 is located within first inlet 308 which through holes directs the mixture towards the turbine blades, allowing them to turn in one direction. Within a passageway 324 in nozzle body 304 is located a static mixer 326. A diffuser 328 is clamped between nozzle tip 306 and nozzle body 304. Within second inlet 310 a viscosity valve 330 allows only low viscosity fluids to pass through it and acts as a second barrier against molten material entering water supply line. The viscosity valve 320 is typically formed from a porous material having passageways through it. These passageways are large enough to allow a low viscosity fluid to flow through them but are too small to allow the higher viscosity thermoplastic material to pass through. The passageways are formed from holes sized at around two thousandth of an inch. The material can, for example, be an acid etched permeable steel or a sintered material.

In use, the nozzle 300 is attached to an injection moulding apparatus and molten thermoplastic passes through injector 322 in first inlet 308 of mixer body 302 which directs the flow towards the turbine mixer 320. From the injector 322, the molten thermoplastic passes into the turbine mixer 320 held in turbine body 318 which is contained in the mixing zone 312. Water passes through viscosity valve 330 and is converted to high pressure steam/vapour which is then fed too and through porous housing 318 and mixed with the thermoplastic material in the turbine mixer 320 which agitates and blends the mixture. The mixture then passes into nozzle body 304 where it is further mixed by static mixer 320 before passing through diffuser 328 where it is blended and stabilised before passing into nozzle tip 306.

As previously described, after passing through nozzle tip 306, the thermoplastic and water mixture which is at a temperature above the boiling point of water passes into the injection mould and the water immediately boils controllably expanding to form bubbles of water vapour within the molten thermoplastic. When cooled, the water condenses within the void leaving a micro droplet, which in a closed void material may act as a fire proofing agent. This function can be further enhanced by the addition of bromide or the like. The foam material can be used for insulation or as a conductor if the liquid inserted is electrically receptive. The material can also be used for shock absorption. The water can also be allowed to escape the outer surface.

Referring to FIGS. 5a and 5b, in which parts common with those of FIGS. 4a and 4b are denoted with like referenced numerals increased by 100, the difference between nozzle 400 and nozzle 300 is the use of a mixer bomb 421 which is contained within a mixer housing 419 and replace the turbine 320 and turbine housing 318. The mixer bomb is a static way of performing the same mixing as the turbine. The mixer bomb is typically formed from a holed part having hole size more of around one thousandth of an inch or is made from a sintered material as is the housing. Both bomb and housing are able to absorb water through their structures and allow evenly release of water into the thermoplastic material. This is likely to be achieved as a high pressure condensed steam by controlled leakage. It should be noted that there is an anti chamber or gap between the turbine/bomb body 318-418 and the mixer body 312. This chamber is flooded with water or steam, to be absorbed throughout the porous parts 318 and 312 and into the thermoplastic. The rate of absorption can be controlled by water volume and melt.

The turbine on the other hand, allows absorption from the housing then turbulently blends it, using a series of integral agitators.

Referring to FIGS. 6 and 7, in which parts in common with FIGS. 4 and 5, are respectively denoted with like reference numeral increased by 200 and 300, the nozzles 500 and 600 are adapted to be used on extrusion apparatus.

Referring to FIGS. 8a, 8b, 9a and 9b, in which parts in common with FIGS. 4a and 4b are respectively denoted with like reference numerals increased by 400, the nozzle 700 is adapted to be used with an injection moulding apparatus (not shown). The nozzle 700, includes a nozzle body 704 and tip 706. It has a first inlet 708 and a second inlet 710. An external thread 716 allows the nozzle 700 to be attached to the injector apparatus (not shown). A passageway 724 extends from the first inlet 708 to the nozzle tip 706 within body 704. The passageway 724 contains a diffuser 732 that is located adjacent the first inlet 708. A shut-off pin 734 extends through diffuser 732, along a passageway 724 to tip 706. A heating element 736 extends along an external surface of nozzle body 704 applying heat to the mixture in passageway 724. Downstream of diffuser 732 a viscosity valve 730 is inserted into second inlet 710. The viscosity valve 730 has an outer body 738 having an aperture 740 extending therethrough and a pin 742. The pin 742 fits into aperture 740 to leave capillary gaps 744 around pin 742. The size of the capillary spaces 744 allows water to pass through the viscosity valve 730 into passageway 724 but does not allow the more viscose molten thermoplastic material to pass from the passageway into the viscosity valve. Referring particularly to FIGS. 9a and 9b, the diffuser 732 has a multiplicity of capillary holes 746 extending therethrough. The holes 746 are typically arranged in lines radially from the centre and, in the example shown, number around 300. A larger aperture 748 accommodates shut-off pin 734.

In use, molten thermoplastic material is injected from an injection moulding apparatus (not shown) through nozzle 700 into a mould (not shown). The injection moulding apparatus and mould are of standard construction and operation and a well known to persons skill in the art. The shut-off pin 734 must be retracted in order to allow molten material to pass through the aperture in nozzle tip 706. Molten plastic material passes through diffuser 732 by being forced under pressure (typically at 40-50 bar) through capillary holes 746. These capillary holes cause the molten plastic material to form into a multiplicity of very fine streams which pass into passageway 724. Water is introduced through viscosity valve 730 and the pressure of the water (typically at 20 bar but could be anything in the range 10 to 200 bar) causes it to mix around the streams of molten material that have just passed from diffuser 732. As the mixture of water and molten plastic material passes along passageway 724 it is further heated by heating element 736. This is necessary for some thermoplastic materials as the introduction of water into the material can remove heat and may therefore thicken the mixture. The mixture then passes through the aperture in nozzle tip 706 and into the mould (not shown) within which the expansion of the thermoplastic material takes place as a result of the vaporisation of the water.

Referring to FIGS. 10a, 10b, 11a and 11b, in which parts in common with FIGS. 8a, 8b, 9a and 9b, are respectively denoted with like reference numerals increased by 100, the nozzle 800 differs from the nozzle 700 in that it does not include the shut-off pin 734 or heating element 736.

Referring to FIG. 12, in which parts in common with FIGS. 8a, 8b, 9a and 9b, are respectively denoted with like reference numerals increased by 200, the nozzle 900 works in essentially the same way as nozzle 700 but includes a static mixer 926. It will be appreciated by persons skilled in the art that the above embodiments have been described by way of example only and not in any limitative sense, and that various alterations and modifications are possible without departure from the scope of the invention as defined by the appended claims.

For example, apparatus of this type is not limited to use with thermoplastic materials. This method could be used with moulding techniques on other materials such as metallic substances, resulting in expansion of these materials using water. Furthermore, the blow foaming liquid need not be water and can be any fluid having a boiling point below the melting point of the thermoplastic or other material being moulded. It is also possible to add additives to the water or other liquid to improve the structure of the product when moulded. For example, mixing of the water into a thermoplastic may be improved by adding a water soluble substance such as glucose or fructose. Furthermore, dyes may be added to the water or liquid dyes used to colour the resulting product.

It should be noted that this method is not restricted to injection moulding and is equally applicable to other moulding techniques as well as to forming extruded products. It should also be noted that the apparatus can be fitted to or formed as part of the mould. This could be done, for example, introducing the water into the molten material as it passes through the mould's central location ring.

This apparatus can also be used to produce a lightweight semi or totally biodegradable product. A biomass, for example oats, can be added to the thermoplastic material and the thermoplastic and biomass are expanded using water in the manner described above. The resulting produce is lightweight and the biomass will degrade over time leaving only the plastic material. The plastic material acts as a binder for the biomass and therefore very little is needed to produce a large volume of expanded material. Such a product is very useful for packaging in particular food packaging.

1-15. (canceled)

16. A method of forming an article from at least one mouldable material, comprising the steps of:—
heating at least one mouldable material to a first temperature at which said material becomes substantially molten;
feeding said molten material through an article forming apparatus; and
introducing at least one liquid into said molten material wherein at least one said liquid boils at a second temperature less than said first temperature.

17. A method according to claim 16, wherein at least one said liquid comprises water.

18. A method according to claim 16, wherein at least one said mouldable material comprises a thermoplastic.

19. A method according to claim 16, wherein said article is formed by injection moulding.

20. A method according to claim 16, wherein said article is formed by extrusion.

21. A liquid adding device for attaching to an apparatus for forming articles from at least one mouldable material, the device comprising:—
at least one insertion device for introducing at least one liquid into an apparatus for forming articles from at least one mouldable material;
at least one valve for allowing the or each liquid to enter said apparatus and mix with at least one said mouldable material and to prevent mouldable material from passing through said valve.

22. A device according to claim 21, wherein said valve comprises a viscosity valve.

23. A device according to claim 21, wherein said viscosity valve comprises at least one permeable mechanism which is porous with regard to the or each liquid and non-porous to said molten material.

24. A device according to claim 22, adapted to be attached to a mould or nozzle of an injection moulding or extrusion apparatus.

25. An apparatus for forming articles from at least one mouldable material, the apparatus comprising:—
at least one healing device for healing at least one mouldable material until it becomes substantially molten;
at least one liquid adding device according to claim 22 for mixing at least one liquid into at least one molten mouldable material; and
at least one shaping device for forming said molten material into at least one article.

26. An apparatus according to claim 25 wherein said at least one shaping device comprises at least one mould.

27. An apparatus according to claim 25 wherein at least one said shaping device comprises at least one extruder.
